(19) United States
(12) Patent Application Publication
(10) Pub. No.: US 2019/0135125 A1
(43) Pub. Date: May 9, 2019

(54) MOBILE ENERGY STORAGE DEVICE

(71) Applicant: FORD GLOBAL TECHNOLOGIES, LLC, Dearborn, MI (US)

(72) Inventors: Arnulf SPONHEIMER, Aachen (DE); Markus KEES, Aachen (DE); Bert HOBEIN, Aachen (DE)

(73) Assignee: FORD GLOBAL TECHNOLOGIES, LLC, Dearborn, MI (US)

(21) Appl. No.: 16/181,034

(22) Filed: Nov. 5, 2018

(30) Foreign Application Priority Data
Nov. 7, 2017 (DE) 10 2017 219 730.7

(51) Int. Cl. B60L 11/18; G05D 1/02

(52) U.S. Cl. CPC B60L 11/1827; G05D 1/0212; B60L 11/1881; B60L 11/1816; B60L 11/182; B60B 19/003; G05D 2201/0213; B60L 2230/12; B60L 2230/14; B60L 2230/28; G05D 1/0276

(57) ABSTRACT

A mobile energy storage device is provided that is arranged to drive autonomously in public traffic to a requested location and to supply energy to a parked electrically powered motor vehicle during the parking time thereof. The energy storage device contains a storage device for hydrogen and a fuel cell and is arranged to charge the parked motor vehicle with electric current that is generated by the fuel cell from the stored hydrogen. A method of charging a vehicle using the mobile energy storage device is also provided.

### CROSS-REFERENCE TO RELATED APPLICATIONS

This application claims foreign priority benefits under 35 U.S.C. § 119(a)-(d) to DE Application 10 2017 219 730.7 filed Nov. 7, 2017, which is hereby incorporated by reference in its entirety.

### TECHNICAL FIELD

Various embodiments relate to a mobile energy storage device that is arranged to drive autonomously to a requested location in public traffic and to supply energy to an electrically powered motor vehicle that is parked there during the parking time thereof, and relate to a method for charging a parked electrically powered motor vehicle via a mobile energy storage device.

### BACKGROUND

Electrically powered motor vehicles, which are understood here to include not only purely battery-operated electric vehicles, but also all types of hybrid electric vehicles with additional combustion engines including plug-in hybrids, require a suitable charging infrastructure. However, the spread of electric mobility that is the aim for emission protection reasons is challenged due to limited space and limited financial means for a sufficient number of charging stations, especially in public areas. For example, in towns with an associated need for emission reductions, many vehicle owners rely on parking their vehicles in public parking spaces, often at the side of the road. Providing sufficient charging stations for emission-free or low-emission motor vehicles may be a slow process based on the associated expense and limited space.

For example, in the year 2015 in Germany there were about seven electrically-powered motor vehicles per public charging station, and it is expected that this mismatch will only increase with increasing numbers of electrically-powered motor vehicles. So that the few public charging stations are not occupied unnecessarily, the permitted parking time at public charging stations is presently limited, and prolonged parking and overnight parking at these public charging stations is not readily possible or is disproportionately expensive. These circumstances may deter vehicle owners that park roadside from operating or purchasing electrically powered motor vehicles.

DE 10 2015 225 789 A1 discloses one version of a mobile energy storage device and a method. When requested, the energy storage device can independently drive in public traffic from a charging station to a location with a need for energy, for example to a location of an electrically powered motor vehicle. The storage device is either an accumulator, or it is a tank for an energy-carrying medium such as for example hydrogen or ethanol. Such self-driving energy storage devices that contain an accumulator can charge the accumulators of parked electrically powered motor vehicles, and such self-driving energy storage devices that contain a hydrogen reservoir can refuel parked motor vehicles that are powered by hydrogen with hydrogen. The mobile energy storage devices may supplement the various static public charging stations for electricity and hydrogen and for promoting the use of emission-free motor vehicles.

### SUMMARY

Various embodiments of the present disclosure are related design mobile energy storage devices so that in particular general electric mobility is promoted even more.

According to an embodiment, a mobile energy storage system is provided that is arranged to drive autonomously in public traffic to a requested location and to supply energy to a parked electrically powered motor vehicle during the parking time thereof. The energy storage device contains a storage device for hydrogen and a fuel cell and is arranged to charge the parked motor vehicle with electric current that is generated by the fuel cell from the stored hydrogen.

According to another embodiment, a method for charging an accumulator of a parked electrically powered motor vehicle by means of a mobile energy storage device is provided. The mobile energy storage device is controlled to drive autonomously in public traffic to a requested location. The accumulator of the vehicle is charged with electric current that is generated by a fuel cell installed in the mobile energy storage device from hydrogen carried by the mobile energy storage device.

According to various examples, the energy storage device embodied as a robot vehicle contains not only a storage device for hydrogen, but also a fuel cell, and is arranged to charge the parked motor vehicle with electric current that is generated by the fuel cell from the stored hydrogen.

This means that the accumulator of the parked motor vehicle is charged with electric current that is generated from hydrogen carried by the mobile energy storage device by a fuel cell installed in the mobile energy storage device.

The energy density of hydrogen reservoirs is greater by a multiple than that of accumulators. Therefore, a mobile energy storage device according to the present disclosure can be made essentially more compact than known mobile energy storage devices with accumulators for the same energy storage capacity, even if said device also contains a fuel cell, wherein a fuel cell is understood to mean the entire corresponding system, in particular a hydrogen-oxygen fuel cell system.

This enables a more compact mobile energy storage device to be implemented, which may therefore find space close to an electrically powered motor vehicle that is parked at the side of the road or in another confirmed parking area. Moreover, a mobile energy storage device of this type, despite the compactness thereof, can charge a plurality of motor vehicles in succession without having to return to a charging station for hydrogen in the meantime.

Indeed, said advantages also exist in the case of known mobile energy storage devices that contain a hydrogen reservoir from which hydrogen vehicles can be refueled, but in these mobile energy storage devices, it is very difficult and complex to automatically couple to the motor vehicle to be refueled with the precision and reliability necessary for handling hydrogen.

By contrast, an electrical coupling between an energy storage device and a motor vehicle to be refueled can be automatically made very much more simply and reliably as is provided in the mobile energy storage device according to the present disclosure.

Electrically powered motor vehicles with accumulators may be more acceptable to the public than hydrogen vehicles or more likely to be widely adopted, so that the spread of emission-free motor vehicles is promoted by the disclosed mobile energy device, since an electrically powered motor vehicle may be simply parked anywhere at the side of the road or similar and automatically charged there.

Owing to the high energy density of hydrogen reservoirs, a very much smaller number of mobile energy storage devices is sufficient to meet charging demand than if these devices were equipped only with accumulators. Moreover, the energy conversion efficiency of fuel cell/hydrogen electricity storage systems is in general better than that of generator/accumulator electricity storage systems.

In various embodiments, the mobile energy storage device carries an essentially smaller road vehicle, or drone vehicle, that is connected thereto via a cable and that is arranged to drive independently to the motor vehicle from the energy storage device that is parked close to the motor vehicle, and to charge the motor vehicle with the electric current from the energy storage device via the cable.

In this case, the mobile energy storage device carries the small cable-connected road vehicle, for example on a lowerable platform that is disposed on the bottom of the mobile energy storage device.

The small cable-connected road vehicle may have a low profile or be flat enough to drive under the parked motor vehicle and may include an induction charging area and/or a CCS charging connector, and a device for raising the induction charging area and/or the CCS charging connector towards the motor vehicle for charging.

The flat design of the cable-connected road vehicle with omnidirectionality movement at the same time, without use of a classic steering system, is achieved by means of traction devices such as individually driven Mecanum running wheels and/or caterpillar tracks for better driving over edges of curbs.

In one example, the mobile energy storage device is preferably about half as long and half as wide and at least as tall as a typical medium class passenger vehicle and with such dimensions can transport at least approximately sixty kilograms of hydrogen.

The storage device for hydrogen may include one or more compressed hydrogen storage tanks, liquid hydrogen storage tanks, metal hydride hydrogen storage tanks and/or LOHC tanks.

### BRIEF DESCRIPTION OF THE DRAWINGS

FIG. 1 illustrates a cycle of charging a motor vehicle via a charging robot up to refueling the charging robot;

FIGS. 2A, 2B, and 2C illustrate schematic sectional views of the charging robot in various operating phases;

FIGS. 3A, 3B, and 3C illustrate some possible relative positions between a motor vehicle and a charging robot during charging;

FIGS. 4A and 4B illustrate a charging robot in longitudinal and lateral sections; and

FIGS. 5A, 5B, 5C, and 5D illustrate schematic sectional views and top views of the motor vehicle and of the charging interfaces thereof.

### DETAILED DESCRIPTION

As required, detailed embodiments of the present disclosure are provided herein; however, it is to be understood that the disclosed embodiments are merely examples and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

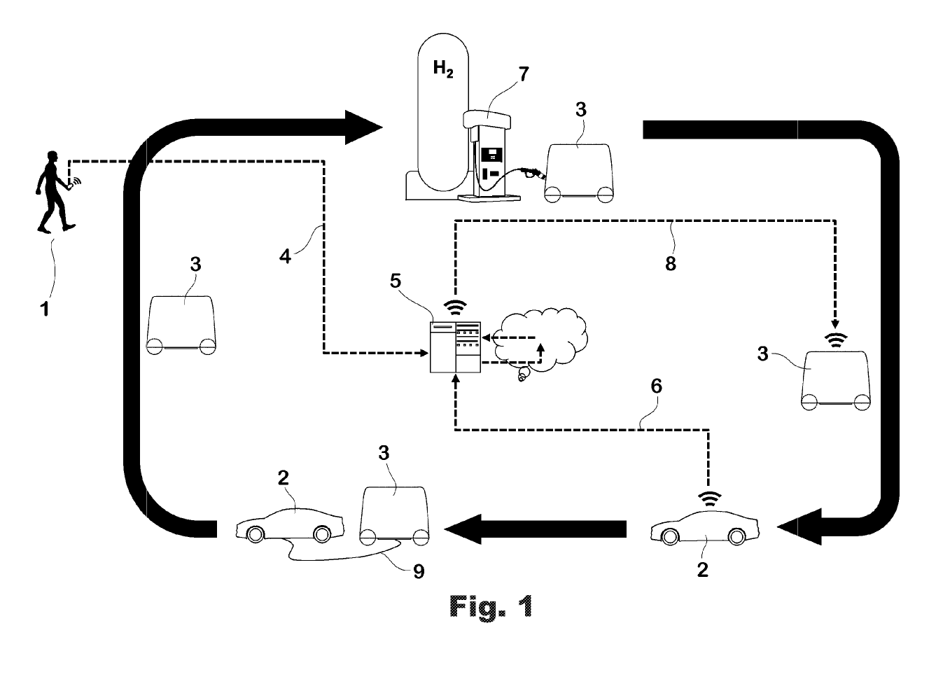

Referring to FIG. 1, an owner 1 of an electrically powered motor vehicle 2 that is parked at a location that can be reached via public roads requests electrical charging of the vehicle 2 by means of an autonomously driving charging robot 3, by for example loading an app, or application, provided by an operator of the charging robot 3 on his smartphone or other device and specifying by means of the app when he expects to want to drive off again and how much electricity is to be charged to the vehicle, for example full or half full.

The smartphone sends this information via a cellular connection 4 to a control center 5, or centralized server, that locates the vehicle 2 by means of a cellular connection 6 and GPS installed in the vehicle 2. The control center 5 can also check the state of charge and the type of the accumulator of the vehicle 2, and whether charging is possible. The vehicle accumulator may be provided by a traction battery or another energy storage device. The controller for the vehicle 2 can check whether there is enough space under the vehicle for the charging robot as described further below, and it can also check the position and the state of charge of the vehicle and can directly send the self-determined data to the control center 4 via a wireless communication network.

The control center 4 processes the charging request using a cloud and intelligent distribution and process planning algorithms to calculate a trajectory or path that the charging robot 3 is to follow and a series of charging services that can be based on the time priority of the charging requests.

The charging robot 3, or robotic vehicle, is a wheeled vehicle with the ability to drive autonomously in public traffic and supplies hydrogen stored in gaseous and/or in liquefied form or reversibly stored by chemical reaction in a storage medium, such as for example a liquid organic hydrogen carrier (LOHC). The charging robot 3 can be refueled at a hydrogen filling station 7, at which it can also be stationed, by service personnel or automatically. Alternatively, the charging robot can also be brought from a decentralized hydrogen filling station with a transport vehicle/transport trailer to an inner-city collection point (“HUB”) and parked there for the next use. After the end of the charging shift, the charging robot 3 drives back to the collection point and is brought back from there, again with the transport vehicle, to the decentralized hydrogen filling station for refueling.

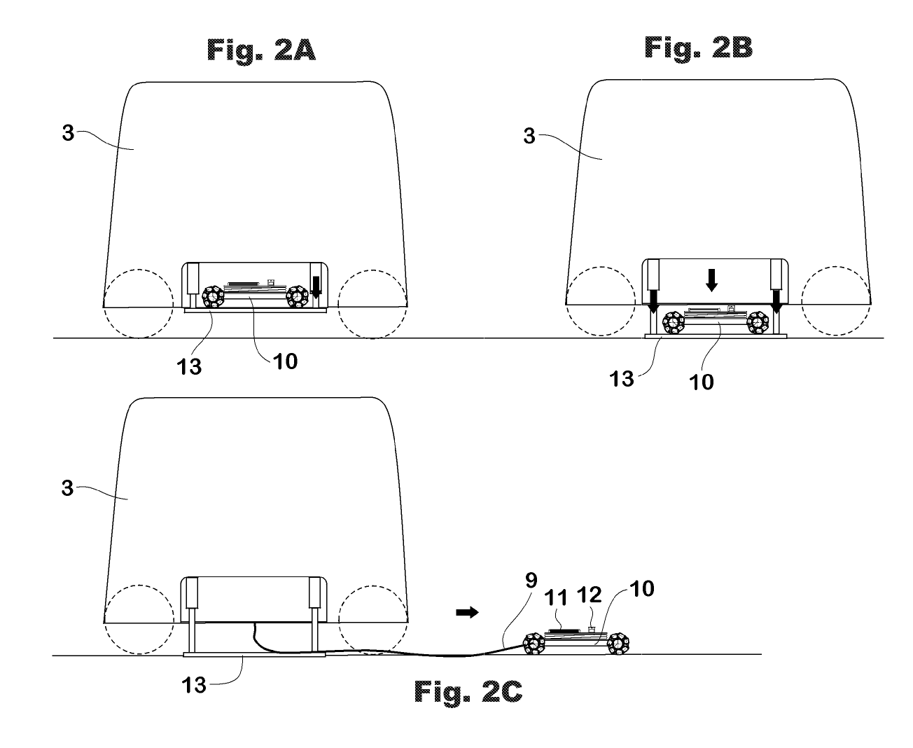

The charging robot 3 is commanded via a cellular or other wireless connection 8 to drive itself to the vehicle 2 to be charged. Once the charging robot 3 has reached the vehicle 2 to be charged, the charging robot 3 enters a so-called “handshake mode” with the vehicle 2 by vehicle-to-vehicle communications, positions itself in the vicinity thereof and releases a small cable-connected road vehicle, referred to below as a drone 10 (See FIGS. 2A-2C). The drone 10 has a maximum height that is less than the ground clearance of a conventional passenger vehicles, for example less than approximately twenty centimeters in height. As a result, the drone 10 can drive under the vehicle 2, and the drone can pull the cable 9 behind itself. These processes can be carried out automatically using environment sensors on the vehicle 2 and on the charging robot 3 and drone 10.

The drone 10 drives to a point under the vehicle 2 adjacent to an induction charging area and/or a standardized electromechanical charging connector, for example according to the Combined Charging System (CCS) standard, is/are installed in the bottom of the vehicle 2. There, the drone 10 independently makes a suitable electrical connection and charges the accumulator or battery of the vehicle 2 via the cable 9 and the electrical connection.

Depending on whether the vehicle 2 comprises an induction charging area or an electromechanical charging connector, or which of the two interfaces enables faster charging, fast DC charging, level 2 3-phase charging, or inductive charging may be carried out if there is a suitable charging device in the vehicle, by means of a DC to AC converter on-board the drone 10.

FIGS. 2A-2C show the charging robot 3 and the drone 10 in the various aforementioned operating phases. As shown in FIG. 2A, the drone 10 normally stands on a lowerable platform 13 on the bottom of the charging robot 3. The platform 13 is movable between a storage position and a lowered position. At the location of the vehicle 2 to be charged, the platform 13 is lowered to road level as shown in FIG. 2B, and the drone 10 drives down from the platform 13 and under the vehicle 2 so that an induction charging area 11 or a CCS charging connector 12 on the drone 10 can interact with the suitable counterpart thereof on the vehicle 2 as shown in FIG. 2C. The drone 10 and the vehicle 2 each include sensor systems that operate, for example, inductively or by infrared or ultrasound, to be able to detect each other so that the drone 10 can orient itself to the vehicle 2.

The drone 10 is equipped with at least a pair of traction devices, such as Mecanum wheels, each of which is driven by a small electric motor and with which the drone 10 can carry out omnidirectional driving maneuvers without requiring a mechanical steering system. Mecanum wheels are described in DE 2 354 404 A1 for example.

The drone 10 takes the drive energy from the charging voltage delivered via the cable 9 by converting the high-voltage power into low-voltage DC power. After the drone 10 has found the correct position under the vehicle 2, the drone raises the assembly of the induction charging area 11 and CCS- charging connector 12 and thus makes the connection to the induction charging area or the CCS charging connector on the bottom of the vehicle, depending on which of said two interfaces on the vehicle 2 is present or more suitable.

The fuel cell system in the charging robot 3 is then operated and begins to produce electric current, and the high-voltage accumulator of the vehicle 2 is charged by means of a DC voltage converter in the charging robot 3. The conversion of the energy stored in the hydrogen into electric current and then subsequently back again produces no other emissions than harmless water vapor, for which reason the mobile energy storage device or charging robot 3 described here and the associated method for charging a vehicle are particularly suitable for cities or other areas that are promoting emission-free traffic or emission-free zones.

When the vehicle 2 charging is finished, the drone 10 breaks the connection with the vehicle 2, drives back to the charging robot 3 and is lifted back into the charging robot 3 to the position shown in FIG. 2A, and the charging robot 3 then drives to the next vehicle to be charged or possibly back to the hydrogen filling station 7.

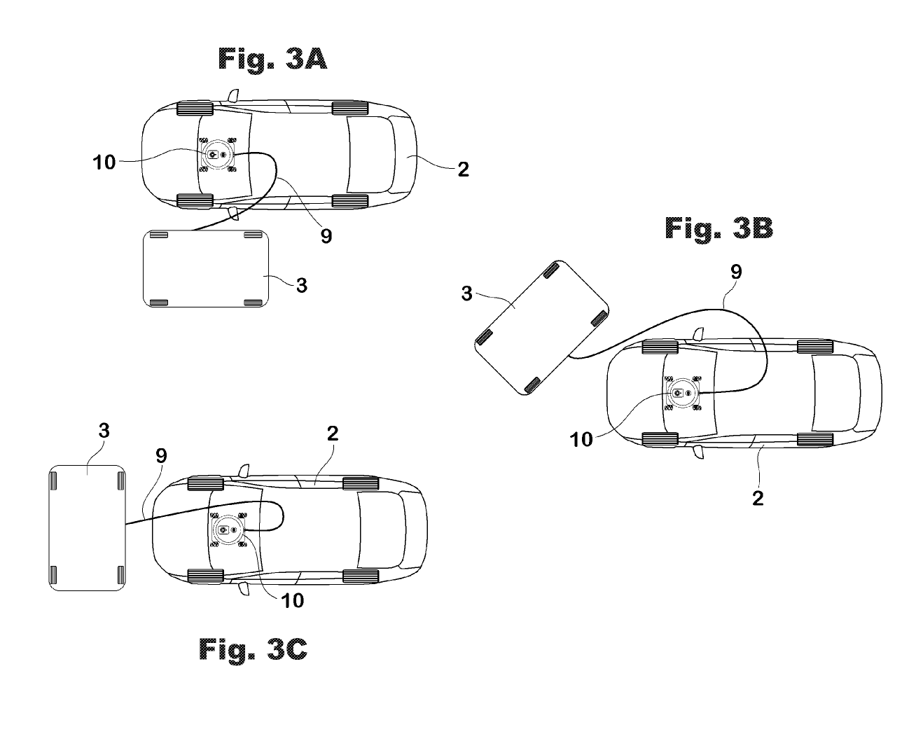

Depending on the amount of hydrogen carried, the charging robot 3 may have various sizes. In one example, the charging robot 3 may be from about half as long to about the full length and about half the width of a medium class passenger vehicle and of a similar height or taller. With such dimensions, the charging robot 3 can take up any position in front of, beside or behind the vehicle 2, in which it can remain for long enough without significantly hindering other traffic. Some possible relative positions between the vehicle 2 and the charging robot 3 during charging are shown in FIGS. 3A-3C. In this case, the vehicle 2 itself can for example be parked along, at an angle to, or at right angles to a road as shown in FIGS. 3A, 3B, and 3C, respectively.

Calculations have shown that a charging robot 3 with the aforementioned dimensions is large enough to store and to transport an amount of hydrogen that is sufficient to charge approximately ten battery electric-vehicles with a 100 kWh battery, 33 battery electric-vehicles with a 30 kWh battery, 100 plug-in hybrid vehicles with a 10 kWh plug-in battery, or correspondingly more vehicles if not all need to be fully charged. The charging robot 3 may enable rapid charging, which typically lasts no longer than approximately one hour, so that the charging robot 3 may fully charge approximately ten vehicles in succession overnight and only then has to be returned to the hydrogen filling station 7.

In a typical real scenario and while also taking into account the driving times between the vehicles to be charged, the present disclosure provides that fifty of such charging robots would suffice to service about 2500 electric-vehicles a day in a town with a mix of battery vehicles with very large and medium storage batteries and plug-in hybrid vehicles.

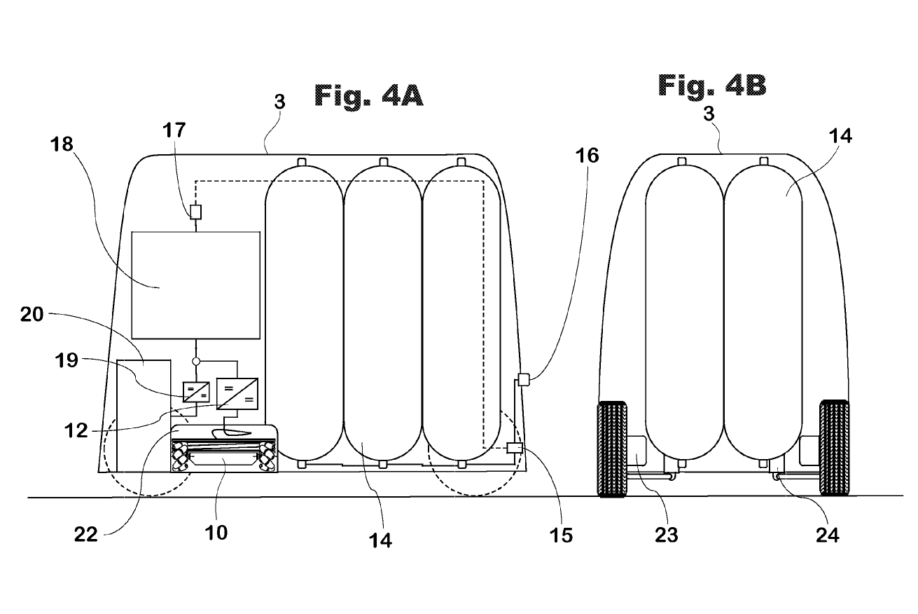

FIG. 4A and 4B shows a charging robot 3 in a longitudinal section and in a lateral section according to an embodiment. In this example, the charging robot 3 contains six standard compressed hydrogen storage tanks 14 for altogether approximately sixty kilograms of hydrogen at 700 bar, with the tanks 14 connected to a refueling opening 16 via a common pressure regulating valve 15.

From the pressure regulating valve 15, a pressure line leads via an isolating valve 17 to a fuel cell 18 (i.e. a fuel cell system), which can produce electric current with a voltage given by the polarization curve of the fuel cell by converting hydrogen and oxygen into water.

The electrical output of the fuel cell 18 is electrically connected via an accumulator-DC converter 19 to a high-voltage accumulator 20 that provides a secondary power supply for peak loads while charging the vehicle 2 using the device 3. The fuel cell 18 can also operate during journeys of the charging robot 3 from application point to application point to charge up the high-voltage accumulator 20.

Moreover, the electrical output of the fuel cell 18 as the primary source of charging current is electrically connected to the drone 10 via a rapid charger-DC converter 21. The drone 10 is accommodated in a drone housing 22.

The charging robot 3 has traction devices, such as wheels, to propel the charging robot on an underlying surface. Two wheels or all four wheels of the charging robot 3 may be each individually driven using hub motors 23, and two wheels or all four wheels of the charging robot 3 may be each steered via steering motors 24.

The charging robot 3 is provided with sensor systems as required for autonomous driving, for example, lidar, radar, video cameras, high-resolution GPS, and odometric sensors for high-resolution measurements of the position of the charging robot 3. The hub motors 23 and steering motors 24 of the charging robot 3 can be supplied with low voltage from an on-board low-voltage system, which is supplied via a voltage converter from the high-voltage accumulator 20 and also supplies all necessary sensors and other electronics with electrical power.

Instead of the compressed hydrogen storage tanks 14, other known types of hydrogen-storage devices may also be used.

Thus, for example, a liquid hydrogen storage system with one or more vacuum-insulated tanks may be used for liquid hydrogen at low temperatures. During extraction, the temperature in the tanks remains constant while hydrogen is continuously released. In this case, the charging robot 3 must additionally contain an evaporation and heating unit for heating the released hydrogen.

As a further example, a metal hydride hydrogen storage system can be used in place of hydrogen storage tanks, in which a chemical bond is made between hydrogen and a metal or an alloy. For example, magnesium hydride powder that is compressed in porous tubes stores hydrogen at ambient temperatures and low pressure. In this case, the charging robot 3 may contain another electric heating device and/or a heat exchanger for faster release of the stored hydrogen from the storage material.

In another example, hydrogen storage in a liquid organic hydrogen carrier (LOHC) may be used on the mobile charging device 3. The tank or tanks thereof contain a separating membrane that separates unused LOHC from used LOHC. Dibenzyl toluene is particularly suitable as the LOHC because of its storage capacity. In this case, the charging robot 3 must also include various components of the LOHC system, in particular a reactor system, a return valve, a fuel pump, an electric heating unit, a pressure regulating valve, an isolating valve, a coolant line from the fuel cell and an outlet opening for used LOHC.

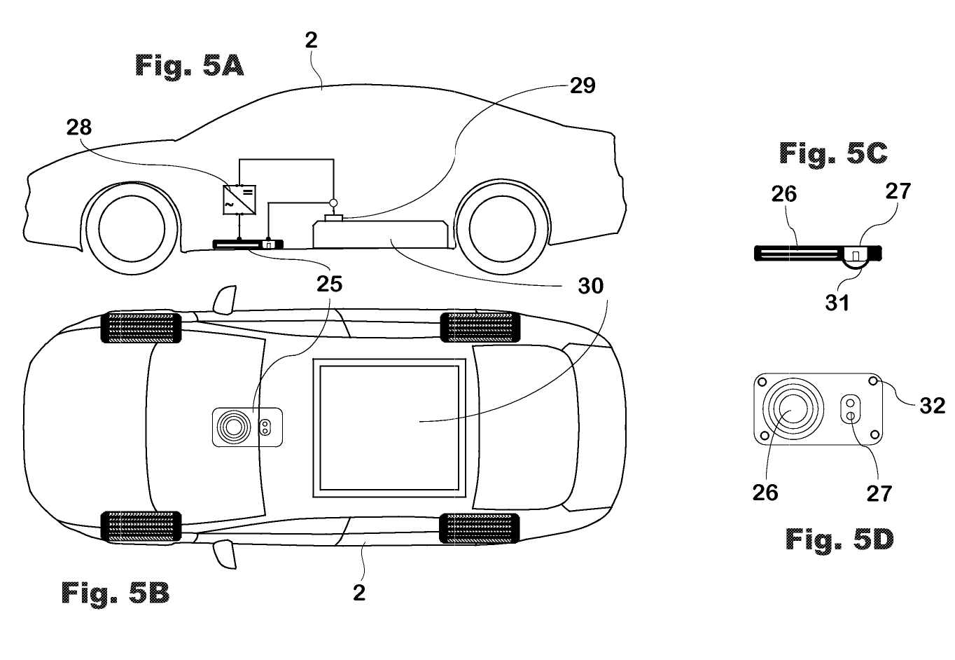

As mentioned above and shown in FIGS. 5A-5D, the vehicle 2 has a charging interface system 25 that is disposed on the bottom or undercarriage of the vehicle and that has an induction charging area 26 and/or a CCS charging connector 27, and a standardized vehicle charging station communications system.

The induction charging area 26 is connected via an AC-to-DC converter 28 to an accumulator connection and management system 29 of a high-voltage accumulator 30, or battery 30, of the vehicle 2. The CCS charging connector 27 is directly connected to the connection 29 of the high-voltage accumulator 30. A protective cap 32 on the CCS charging connector 27 is opened by the CCS charging connector 12 on the drone 10 if the charging interface unit thereof is lifted. Just as on the drone 10, position sensors 32 and/or actuators are also disposed on the charging interface system 25, using which the drone 10 can be correctly positioned under the vehicle 2 and can be connected thereto.

The mobile energy storage device or charging robot 3 described here and the described method make the daily search for an unoccupied charging station by owners of electrically powered motor vehicles obsolete. They can have their vehicles charged when the time suits them and do not have to unpark or move the vehicle when the charging is finished.

Moreover, the number of public charging stations required can be drastically reduced, which saves high investment costs for charging infrastructure. The mobile energy storage device or charging robot 3 and the described method also reduce the traffic associated with the search for fixed charging stations, since because of the hydrogen energy carrier the charging robot 3 can store a multiple of the amount of energy that could be stored in correspondingly heavy and large accumulators, so that each charging robot 3 can charge a plurality of motor vehicles and in doing so can take an optimized route before having to refuel with hydrogen.

Furthermore, peak loads on the power supply system, or electrical grid, are reduced, because charging is decoupled in time from the current load on the power supply system. The hydrogen can be produced from renewable energy, and at times at which particularly large amounts of electricity generation occur, for example from wind turbines and solar panels. A large number of charging robots 3 therefore act as energy storage devices and form a time buffer between electricity generation and electricity consumption.

The charging robot 3 can also be required to carry out rapid charging of electrically powered vehicles that have been left with too little charge and can also be used for refueling hydrogen-powered vehicles if suitable connections are available. The charging robot 3 can also be requested for temporary power supplies for property, for example in the event of power failures owing to construction works or natural disasters, or for temporary power supplies for construction machinery, for example.

While various embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. A mobile energy storage system comprising:
a robotic vehicle configured to drive autonomously to a requested location associated with a parked electrically powered motor vehicle and to electrically couple with the motor vehicle;
a hydrogen storage device supported by the robotic vehicle; and
a fuel cell connected to the hydrogen storage device and supported by the robotic vehicle, wherein the fuel cell generates electric current from stored hydrogen in the hydrogen storage device;
wherein the robotic vehicle supplies electrical energy to charge the motor vehicle using the electric current from the fuel cell.

2. The mobile energy storage system of claim 1, further comprising a road vehicle connected to the robotic vehicle via a cable, the road vehicle to drive from the robotic vehicle to the motor vehicle when the robotic vehicle is parked near the motor vehicle, the road vehicle to charge the motor vehicle with the electric current from the robotic vehicle via the cable.

3. The mobile energy storage system of claim 2, wherein the robotic vehicle has a platform moveable from a storage position to a lowered position, the platform to carry the road vehicle when the robotic vehicle is in motion.

4. The mobile energy storage system of claim 2, wherein the road vehicle has a maximum height that is less than a clearance beneath the motor vehicle when parked on a flat surface such that the road vehicle is driveable underneath the motor vehicle.

5. The mobile energy storage system of claim 2 wherein the road vehicle comprises an induction charging area and/or a Combined Charging System (CCS) charging connector.

6. The mobile energy storage system of claim 2, wherein the road vehicle comprises at least two individually driven Mecanum running wheels and/or caterpillar tracks.

7. The mobile energy storage system of claim 1, wherein the hydrogen storage device has a storage capacity of at least sixty kilograms of hydrogen; and
wherein the robotic vehicle has a length ranging from half a length to a full length of a medium class passenger vehicle, a width of half a width of the medium class passenger vehicle, and a height that is at least a height of the medium class passenger vehicle.

8. The mobile energy storage system of claim 1, wherein the hydrogen storage device has a capacity sized to store hydrogen to carry out ten successive charging processes on electrically powered vehicles with storage batteries.

9. The mobile energy storage system of claim 1 wherein the hydrogen storage device includes a compressed hydrogen storage tank, a liquid hydrogen storage tank, a metal hydride hydrogen storage tank, and/or a liquid organic hydrogen carrier (LOHC) tank.

10. A method comprising:
autonomously driving a robotic vehicle to a requested location associated with a parked electrically powered motor vehicle;
generating electric current on-board the robotic vehicle using a fuel cell connected to a hydrogen storage device; and
charging an energy storage device of the motor vehicle using the electric current from the fuel cell.

11. The method of claim 10 wherein autonomously driving the robotic vehicle further comprises receiving a signal indicative of a location and a battery status of the motor vehicle from a database in a control center, the signal received by a controller of the robotic vehicle.

12. A mobile charging system comprising:
a robotic vehicle with a controller to autonomously drive to a parked electric motor vehicle;
a fuel cell system and associated hydrogen storage device supported by the robotic vehicle to generate electrical current; and
a connector to electrically couple with the motor vehicle to charge the motor vehicle using electrical current generated by the fuel cell system.

13. The mobile charging system of claim 12 further comprising a secondary vehicle connected to the robotic vehicle via a cable, the secondary vehicle having the connector thereon.

14. The mobile charging system of claim 13 wherein the connector is an induction charging area, an electromechanical charging connector, or a combination thereof.

15. The mobile charging system of claim 13 wherein the secondary vehicle is supported by a pair of traction devices.

16. The mobile charging system of claim 15 wherein a maximum height of the secondary vehicle is less than twenty centimeters such that the secondary vehicle is sized to drive beneath an undercarriage of the motor vehicle; and
wherein the controller is configured to control the secondary vehicle to move independently of the robotic vehicle.

17. The mobile charging system of claim 13 wherein the robotic vehicle has a platform movable between a storage position and a road level position, the platform sized to receive the secondary vehicle.

18. The mobile charging system of claim 13 wherein the controller of the robotic vehicle is configured to communicate with a central server and with the motor vehicle; and
wherein the secondary vehicle has a sensor system to detect the motor vehicle and orient the secondary vehicle relative thereto.

19. The mobile charging system of claim 12 further comprising a battery supported by the robotic vehicle and electrically coupled to the fuel cell system and the connector to charge the motor vehicle.

20. The mobile charging system of claim 12 wherein the robotic vehicle is supported by a pair of traction devices, each traction device having an associated hub motor.
